(19) United States
(12) Patent Application Publication
(10) Pub. No.: US 2013/0155567 A1
(43) Pub. Date: Jun. 20, 2013

(54) DISCHARGE ELECTRODE, METHOD FOR MANUFACTURING DISCHARGE ELECTRODE, ION GENERATING APPARATUS, AND ELECTROSTATIC ATOMIZING APPARATUS

(71) Applicants: Takayuki Nakada, Shiga (JP); Takafumi Omori, Shiga (JP); Yusuke Yamada, Shiga (JP); Kazunobu Nakata, Gifu (JP); Toshihiro Ito, Shiga (JP); Takashi Kozai, Shiga (JP); Shinya Murase, Shiga (JP)

(72) Inventors: Takayuki Nakada, Shiga (JP); Takafumi Omori, Shiga (JP); Yusuke Yamada, Shiga (JP); Kazunobu Nakata, Gifu (JP); Toshihiro Ito, Shiga (JP); Takashi Kozai, Shiga (JP); Shinya Murase, Shiga (JP)

(73) Assignee: PANASONIC CORPORATION, Kadoma-shi, Osaka (JP)

(21) Appl. No.: 13/819,187

(22) PCT Filed: Sep. 6, 2011
(86) PCT No.: PCT/JP2011/070254

§ 371 Date: Feb. 26, 2013

(30) Foreign Application Priority Data
Sep. 27, 2010 (JP) 2010-215173

(51) Int. Cl. B05B 5/053; H01T 23/00; H01J 9/02

(52) U.S. Cl. CPC B05B 5/0536; H01J 9/02; H01T 23/00
USPC 361/228; 313/310; 445/50; 315/326

(57) ABSTRACT

A discharge electrode includes a surface layer to which a surface treatment that enables solder bonding is applied.

### TECHNICAL FIELD

The present invention relates to a discharge electrode used to generate charged micro-particle water and ions, a method for manufacturing the discharge electrode, an ion generating apparatus including the discharge electrode, and an electrostatic atomizing apparatus including the discharge electrode.

### BACKGROUND ART

An electrostatic atomizing apparatus is conventionally known. The electrostatic atomizing apparatus applies a high voltage to a discharge electrode to discharge and atomize water held on a discharge portion of the discharge electrode, and thereby forms charged micro-particle water that is weakly acidic. An ion generating apparatus is also known that applies a high voltage to a discharge portion to perform discharging so as to generate negative ions. Charged micro-particle water and negative ions contribute to moisturizing of skin and hair, deodorization of space and objects, and the like. Therefore, electrostatic atomizing apparatuses and ion generating apparatuses are installed in various products so as to obtain diverse effects.

In an electrostatic atomizing apparatus described in Patent Document 1, Peltier effect is used to cool a discharge electrode to supply water to the discharge electrode. A Peltier unit that cools the discharge electrode in the electrostatic atomizing apparatus includes two circuit boards and a plurality of thermoelectric elements. The thermoelectric elements are sandwiched between the two circuit boards. Each circuit board is formed of an insulating plate having a circuit portion formed on one side surface. The circuit boards are arranged so that they oppose each other and adjacent thermoelectric elements are electrically connected to each other by the two circuit portions. The discharge electrode is connected via a cooling insulating plate to one of the circuit boards that serves as a heat absorbing side, and a heat radiating plate is connected to the other one of the circuit boards that serves as a heat radiating side. In this electrostatic atomizing apparatus, when current flows through the thermoelectric elements, the heat absorbing side of the thermoelectric elements cools the discharge electrode via the circuit portion, the insulating plate, and the cooling insulating plate. By this cooling, condensed water is formed on a surface of the discharge electrode.

In the electrostatic atomizing apparatus according to Patent Document 1, several interfaces are present between the thermoelectric elements and the discharge electrode. That is, an interface of the thermoelectric elements and the circuit portion, an interface of the circuit portion and the insulating plate, an interface of the insulating plate and the cooling insulating plate, and an interface of the cooling insulating plate and the discharge electrode are present between the thermoelectric elements and the discharge electrode. These several interfaces lower an efficiency of cooling of the discharge electrode. Therefore, there is a need to dispose a large number of thermoelectric elements to secure a sufficient cooling ability for forming condensed water on the surface of the discharge electrode. This causes enlargement of the apparatus as a whole and inhibits energy saving.

### PRIOR ART DOCUMENTS

Patent Document 1: Japanese Laid-Open Patent Publication No. 2006-826

### SUMMARY OF THE INVENTION

### Problems to be Solved by the Invention

As a method of reducing the number of thermoelectric elements, direct connection of the thermoelectric elements and the discharge electrode by solder bonding may be performed to electrically connect adjacent thermoelectric elements to each other. By doing so, the number of interfaces between the thermoelectric elements and the discharge electrode is reduced, thereby enabling the electrostatic atomizing apparatus to be made compact and energy saving to be achieved.

However, as described in Patent Document 1, the discharge electrode may be formed of a metal having high thermal conductivity (for example, titanium). In a case where the discharge electrode is formed of a metal of high thermal conductivity, it is difficult to directly connect the discharge electrode and the thermoelectric elements by solder bonding.

Accordingly, it is an object of the present invention to provide a discharge electrode that can readily be connected directly to a thermoelectric element by solder bonding even when the electrode is formed of a metal having high thermal conductivity, a method for manufacturing the discharge electrode, an ion generating apparatus including the discharge electrode, and an electrostatic atomizing apparatus including the discharge electrode.

### Means for Solving the Problems

A first aspect of the present invention is a discharge electrode. The discharge electrode includes a surface layer to which a surface treatment that enables solder bonding is applied. According to this structure, even when the discharge electrode is formed of a metal having high thermal conductivity, a thermoelectric element can be connected by solder bonding directly to the surface layer of the discharge electrode that has been surface treated.

A second aspect of the present invention is a method for manufacturing a discharge electrode. The method includes a surface treatment step of applying a surface treatment, which enables solder bonding, to a wire rod, a cutting step of cutting the wire rod to form a cut rod, and a discharge portion forming step of forming a discharge portion at a distal portion of the cut rod. According to this method, a discharge electrode that can be connected directly to a thermoelectric element by solder bonding is provided.

A third aspect of the present invention is an ion generating apparatus. The apparatus includes the discharge electrode according to the first aspect and a high voltage applying unit that applies a high voltage to the discharge electrode to generate ions by discharging.

A fourth aspect of the present invention is an electrostatic atomizing apparatus. The apparatus includes a discharge electrode according to the first aspect, a water supplying unit that supplies water to the discharge electrode, and a high voltage applying unit that applies a high voltage to the discharge electrode holding the water to form charged micro-particle water by discharging.

### BRIEF DESCRIPTION OF THE DRAWINGS

FIG. 1 is a schematic diagram of an electrostatic atomizing apparatus.

FIG. 2 is a perspective view of a wire rod and a cut rod.

FIG. 3A is a schematic diagram illustrating a chamfering step and FIG. 3B is a side view of the cut rod.

FIG. 4A is a side view of the cut rod and FIG. 4B is a front view of the cut rod.

FIG. 5A is a side view of the cut rod and FIG. 5B is a front view of the cut rod.

FIG. 6 is a schematic diagram illustrating a discharge portion forming step.

### EMBODIMENTS OF THE INVENTION

A discharge electrode according to one embodiment will now be described with reference to the drawings. In the present embodiment, the discharge electrode is, for example, applied in an electrostatic atomizing apparatus.

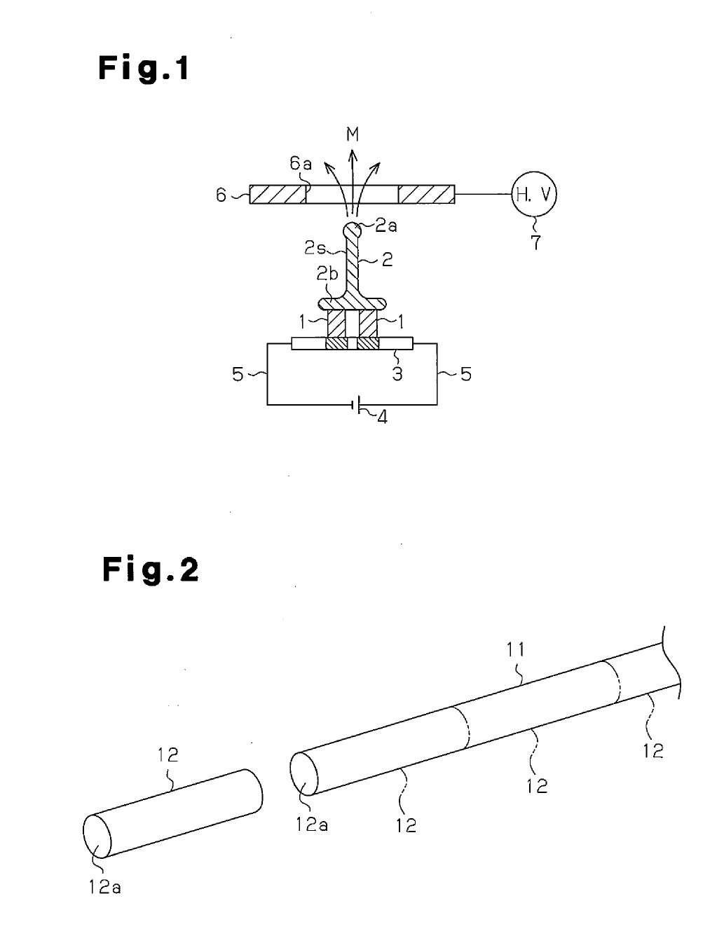

FIG. 1 illustrates a schematic diagram of the electrostatic atomizing apparatus. The electrostatic atomizing apparatus includes a pair of P type and N type thermoelectric elements 1. The thermoelectric elements 1 are, for example, BiTe-based Peltier elements. Heat absorbing sides (upper sides in FIG. 1) of the thermoelectric elements 1 is directly connected mechanically and electrically to a discharge electrode 2 by solder bonding.

The discharge electrode 2 that has a substantially cylindrical shape undergoes a plating treatment as a surface treatment that enables solder bonding. For example, the discharge electrode 2 is formed of a titanium rod (cut rod 12 described later) with a nickel plating applied thereto. That is, the discharge electrode 2 includes a surface layer 2s to which the nickel plating is applied. Further, the discharge electrode 2 includes a spherical discharge portion 2a, which is formed at a distal portion of the discharge electrode 2, and a flange-shaped base portion 2b, which is formed at a basal portion of the discharge electrode 2 and extends radially outward. In an axial direction of the discharge electrode 2, an end surface of the base portion 2b at a side opposite to the discharge portion 2a, that is, a base end surface of the discharge electrode 2 is directly connected mechanically and electrically by solder bonding to the heat absorbing sides of the thermoelectric elements 1. That is, the base portion 2b of the discharge electrode 2 is installed on the heat absorbing sides of the thermoelectric elements 1. The surface of the base portion 2b undergoes the nickel plating. Thus, the solder bonding of the base portion 2b and the thermoelectric elements 1 is performed satisfactorily. The thermoelectric elements 1 are electrically connected via the discharge electrode 2.

Heat radiating sides (lower sides in FIG. 1) of the thermoelectric elements 1 are respectively directly connected mechanically and electrically to heat radiating conductive members 3. The heat radiating conductive members 3 are formed of a material (brass, aluminum, copper, or the like) having electrical conductivity and thermal conductivity. The heat radiating conductive members 3, which are connected to the thermoelectric elements 1, are electrically connected to each other by lead wires 5 via a voltage applying unit 4 that is a DC power supply. In the present embodiment, the thermoelectric elements 1, the heat radiating conductive members 3, the voltage applying unit 4, and the lead wires 5 form a water supplying unit.

An opposing electrode 6 is arranged at a position opposing the discharge portion 2a of the discharge electrode 2. The opposing electrode 6 has an annular shape and includes an emission hole 6a formed at a center of the electrode 6. The opposing electrode 6 is connected to a high voltage applying unit 7.

In the electrostatic atomizing apparatus described above, when current supplied from the voltage applying unit 4 flows through the thermoelectric elements 1 via the discharge electrode 2, the discharge electrode 2 is directly cooled by an action of the thermoelectric elements 1. Air in the surroundings of the discharge electrode 2 is thereby cooled, and condensed water formed from the moisture in the air is attached to the surface of the discharge electrode 2. In a state in which water is held on the surface of the discharge electrode 2 and especially the discharge portion 2a, a high voltage is applied between the discharge electrode 2 and the opposing electrode 6 by the high voltage applying unit 7 in a manner such that the discharge electrode 2 serves as a negative electrode at which charges concentrate. The water held on the discharge portion 2a is drawn up toward the opposing electrode 6 by an electrostatic force to form a shape called a Taylor cone. Thus, the water held on the discharge portion 2a receives a large energy and undergoes Rayleigh fission repeatedly to form a large amount of charged micro-particle water M. The charged micro-particle water M that is formed is attracted to the opposing electrode 6 and emitted to an exterior of the electrostatic atomizing apparatus through the emission hole 6a of the opposing electrode 6.

A method for manufacturing the discharge electrode 2 will now be described.

First, as illustrated in FIG. 2, a surface treatment step of applying a surface treatment, which enables solder bonding, to a wire rod 11, which is formed of a metal having high thermal conductivity, is performed. In the surface treatment step of the present embodiment, a nickel plating is applied to the wire rod 11 formed of titanium. For example, the wire rod 11 has a diameter of 0.75 [mm].

Next, a cutting step of cutting the wire rod 11 to which the nickel plating has been applied is performed. In the cutting step, the wire rod 11 to which the nickel plating has been applied is cut to form a cut rod 12 that is to be the discharge electrode 2. The cut rod 12 has circular cross-sectional shape.

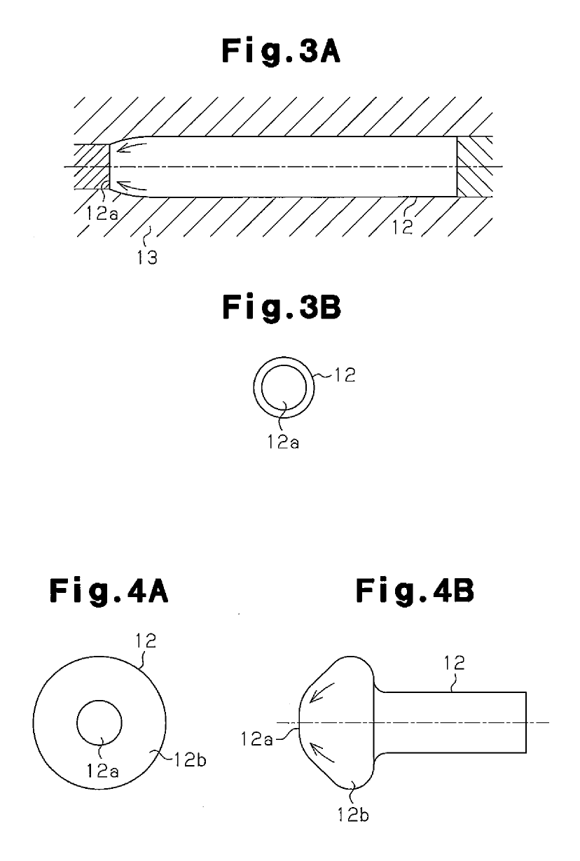

Next, a chamfering step of applying a chamfering process to the cut rod 12 is performed. As illustrated in FIG. 3A and FIG. 3B, in the chamfering step, a chamfering process using a heading process apparatus (not illustrated) for chamfering is applied to a base end portion of the cut rod 12 (one end portion of the cut rod 12 in an axial direction which is the end portion at a left side in FIG. 3A). The base end portion of the cut rod 12 is chamfered so that the material of the cut rod 12 flows along an inner peripheral surface of a forming die 13 of the heading process apparatus toward a base end surface of the cut rod 12 and radially inward (see arrows in FIG. 3A). The base end portion of the cut rod 12 is thus reduced in diameter so that the base end surface of the cut rod 12, that is, a cut surface 12a formed by cutting of the wire rod 11 in the cutting step (see FIG. 2) is made smaller.

Next, a base portion forming step of forming the base portion 2b at the base end portion of the cut rod 12 is performed. In the base portion forming step, first, as illustrated in FIG. 4B, a heading process is applied to the cut rod 12 by a heading process apparatus (not illustrated) for forming the base portion 2b to form a diameter-expanded portion 12b, which has a larger outer diameter than a distal portion of the cut rod 12, at the base end portion of the cut rod 12. Here, the base end portion of the cut rod 12 has been chamfered in the chamfering step and thus the material of the cut rod 12 flows so as to make the cut surface 12a small as indicated by an arrow in FIG. 4B. Therefore, as illustrated in FIG. 4A, the cut surface 12a, to which the nickel plating is not applied, is suppressed from being enlarged at the base end portion of the cut rod 12.

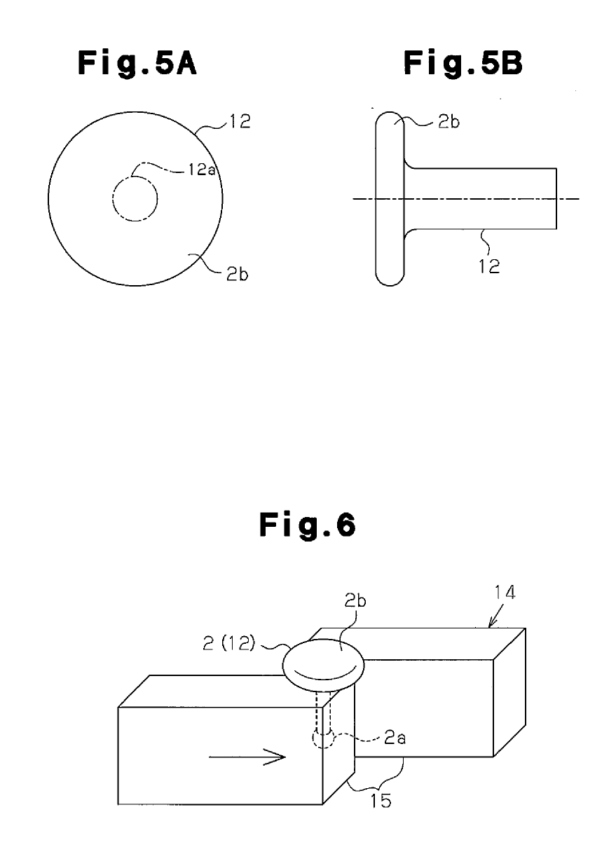

Next, as illustrated in FIG. 5A, a heading process is applied to the cut rod 12 by the heading process apparatus (not illustrated) for forming the base portion 2b to compress the diameter-expanded portion 12b so that a thickness of the diameter-expanded portion 12b in the axial direction is thinned. Thus, the flange-shaped base portion 2b that extends radially outward is formed at the base end portion of the cut rod 12. In this process as well, the material of the cut rod 12 flows so as to make the cut surface 12a small because chamfering has been applied to the base end portion of the cut rod 12 in the chamfering step. Therefore, as illustrated in FIG. 5A, the cut surface 12a, to which the nickel plating is not applied, is suppressed from being enlarged in the process of compressing the diameter-expanded portion 12b and forming the flange-shaped base portion 2b. Thus, an area of the nickel plating of a portion that is solder-bonded with the thermoelectric elements 1 may be secured at the base portion 2a.

Next, as illustrated in FIG. 6, a discharge portion forming step of forming the discharge portion 2a at the distal portion of the cut rod 12 is performed. In the discharge portion forming step, the distal portion of the cut rod 12, which includes the base portion 2b, is positioned between a pair of rolling dies 15 of a rolling process apparatus 14. Then, the rolling dies 15 are slidingly moved in mutually opposite directions to form the spherical discharge portion 2a at the distal portion of the cut rod 12 by a rolling process. In this manner, the discharge electrode 2 having the nickel plating applied to its surface is manufactured.

Thereafter, an inspection step of performing an appearance inspection of the manufactured discharge electrode 2 is performed. In the inspection step, a discharge electrode 2 that does not meet appearance standards that have been set in advance is eliminated.

The present embodiment has the advantages described below.

(1) The discharge electrode 2 includes the surface layer 2s to which the surface treatment that enables solder bonding (the nickel plating in the present embodiment) is applied. Thus, even when the discharge electrode 2 is formed of a metal having high thermal conductivity (titanium in the present embodiment), the discharge electrode 2 and the thermoelectric elements 1 may be readily connected directly by solder bonding.

(2) The surface treatment applied to the discharge electrode 2 is a plating treatment, and thus the surface treatment that enables solder bonding may be performed readily. Further, when the surface treatment applied to the discharge electrode 2 is a plating treatment, regardless of before, after, or during the forming of the discharge electrode 2, the plating treatment may be applied to the metal of the discharge electrode 2 so that the discharge electrode 2 includes the surface layer 2a to which the surface treatment has been applied.

(3) The plating treatment applied to the discharge electrode 2 is nickel plating, and thus the discharge electrode 2 and the thermoelectric elements 1 may be directly connected more readily by solder.

(4) When the surface treatment that enables solder bonding is applied to the discharge electrode 2, solder bonding of the discharge electrode 2 and the thermoelectric elements 1 may be performed satisfactorily. However, the discharge electrode is a small component and thus if the plating treatment is applied to the discharge electrode after the discharge electrode has been formed, the conveying of the discharge electrode to the plating step and the components management is troublesome. This consequently may lead to rise of manufacturing cost. In this regard, the discharge electrode 2 of the present embodiment is formed from the titanium cut rod 12 to which the nickel plating has been applied. In this case, the step of applying the nickel plating to the surface of the discharge electrode does not have to be performed after forming the discharge electrode.

Thus, the trouble of conveying and components control of the discharge electrode, which is a small component, is eliminated. Accordingly, the manufacture of the discharge electrode 2 is easy and consequently, the manufacturing cost may be reduced.

(5) The discharge portion 2a is formed by the rolling process. Thus, productivity is improved in comparison to forming the discharge portion by using, for example, a cutting process. Accordingly, the manufacturing cost of the discharge electrode 2 may be reduced further.

(6) The base portion 2b is formed by the heading process. Thus, the productivity is improved in comparison to forming the base portion by using, for example, a cutting process. Accordingly, the manufacturing cost of the discharge electrode 2 may be reduced further. In addition, when the flange-shaped base portion 2b is formed at the base end portion of the discharge electrode 2, an area of the discharge electrode 2 that is solder-bonded with the thermoelectric elements 1 becomes large. Thus, the solder bonding of the discharge electrode 2 and the thermoelectric elements 1 may be performed even more readily.

(7) The electrostatic atomizing apparatus may be manufactured readily because it includes the discharge electrode 2 that can be connected directly to the thermoelectric elements 1 by solder bonding. Further, the manufacturing cost of the electrostatic atomizing apparatus is reduced because the apparatus includes the discharge electrode 2 that is more easily manufactured and thus, less costly to manufacture.

(8) The wire rod 11 to which the nickel plating is applied in the plating step is larger than the discharge electrode 2. Thus, the application of nickel plating to the wire rod 11 may be performed more readily than the application of nickel plating to the small discharge electrode 2.

The above embodiment may be modified as described below.

In the above embodiment, the electrostatic atomizing apparatus includes only a pair of thermoelectric elements 1, but may include a plurality of pairs of thermoelectric elements 1.

In the above embodiment, the electrostatic atomizing apparatus is formed so that a high voltage is applied between the discharge electrode 2 and the opposing electrode 6 that is arranged opposite to the discharge portion 2a of the discharge electrode 2. However, the electrostatic atomizing apparatus may not include the opposing electrode 6. In this case, a high voltage may be applied to the discharge electrode 2. Further, in lieu of the opposing electrode 6, a static elimination plate or other component of the electrostatic atomizing apparatus that is arranged at a periphery of the discharge electrode 2 may be used as an opposing electrode.

In the above embodiment, the discharge electrode 2 is included in the electrostatic atomizing apparatus that generates the charged micro-particle water M by discharging. However, the discharge electrode 2 may also be used in an ion generating apparatus that generates ions (negative ions, such as O₂ ions and OH ions) by discharging. In this case, the ion generating apparatus includes the discharge electrode 2 that may be readily connected directly to the thermoelectric elements 1 by solder bonding, and thus may be manufactured readily. Further, since the discharge electrode 2 is more easily manufactured and thereby less costly to manufacture, the ion generating apparatus less costly to manufacture.

The shape of the base portion 2b is not limited to a flange shape. The base portion 2b suffices to have a shape that projects radially outward and enables the discharge electrode 2 to be installed on the heat absorbing sides of the thermoelectric elements 1.

In the above embodiment, the discharge portion 2a is formed by the rolling process. However, the discharge portion 2a may be formed by a cutting process or any process other than the rolling process.

In the above embodiment, the discharge electrode 2 is formed of the titanium cut rod 12 to which the nickel plating is applied. However, the discharge electrode 2 may be formed of a metal having high thermal conductivity other than titanium (aluminum, copper, tungsten, stainless steel, or the like). In this case, when the discharge electrode 2 is formed of a rod to which a plating treatment (the surface treatment that enables solder bonding) is applied, the same advantages as those of (4) of the above embodiment may be obtained.

In the above embodiment, the nickel plating is applied to the surface of the discharge electrode 2. However, the plating treatment applied to the surface of the discharge electrode 2 is not limited to nickel plating and may be a plating treatment using a material (for example, tin) that enable direct bonding of the discharge electrode 2 and the thermoelectric elements 1 by solder.

In the above embodiment, as the surface treatment that enables solder bonding, the plating treatment (nickel plating) is applied to the discharge electrode 2. However, the surface treatment applied to the discharge electrode 2 is not limited to the plating treatment as long as it is a surface treatment that enables solder bonding. For example, as the surface treatment that enables solder bonding, a surface roughening treatment may be applied to the surface of the discharge electrode 2.

In the above embodiment, the cut rod 12 has a rod shape with a circular cross-sectional shape. However, as long as the cut rod 12 has a rod shape, its cross-sectional shape may be an elliptical shape, polygonal shape, and the like. Further, the diameter of the wire rod 11 may be selected as appropriate in accordance with the size of the discharge electrode 2 to be formed.

1. A discharge electrode comprising a surface layer to which a surface treatment that enables solder bonding is applied.

2. The discharge electrode according to claim 1, wherein the surface treatment is a plating treatment.

3. The discharge electrode according to claim 2, wherein the plating treatment is a nickel plating.

4. The discharge electrode according to claim 3, wherein the discharge electrode is formed of a rod that is made of titanium to which the nickel plating is applied.

5. The discharge electrode according to claim 1, comprising a distal portion including a discharge portion formed by a rolling process.

6. The discharge electrode according to claim 1, comprising a base end portion including a flange-shaped base portion formed by a heading process.

7. A method for manufacturing a discharge electrode comprising:
a surface treatment step of applying a surface treatment, which enables solder bonding, to a wire rod;
a cutting step of cutting the wire rod to form a cut rod; and
a discharge portion forming step of forming a discharge portion at a distal portion of the cut rod.

8. The method for manufacturing a discharge electrode according to claim 7, wherein the surface treatment step includes applying a plating treatment to the wire rod.

9. The method for manufacturing a discharge electrode according to claim 8, wherein the plating treatment is a nickel plating.

10. The method for manufacturing a discharge electrode according to claim 9, wherein the wire rod is made of titanium.

11. The method for manufacturing a discharge electrode according to claim 7, further comprising a base portion forming step of forming a flange-shaped base portion, for installation of the discharge electrode, at a base end portion of the cut rod by a heading process.

12. The method for manufacturing a discharge electrode according to claim 7, wherein the discharge portion forming step includes forming the discharge portion by a rolling process.

13. An ion generating apparatus comprising:
the discharge electrode according to claim 1; and
a high voltage applying unit that applies a high voltage to the discharge electrode to generate ions by discharging.

14. An electrostatic atomizing apparatus comprising:
the discharge electrode according to claim 1;
a water supplying unit that supplies water to the discharge electrode; and
a high voltage applying unit that applies a high voltage to the discharge electrode holding the water to form charged micro-particle water by discharging.
